(19) United States
(12) Patent Application Publication
(10) Pub. No.: US 2022/0203481 A1
(43) Pub. Date: Jun. 30, 2022

(54) DONUT KEYHOLE LASER CUTTING

(71) Applicant: American Air Liquide, Inc., Fremont, CA (US)

(72) Inventor: Charles CARISTAN, Conshohocken, PA (US)

(21) Appl. No.: 17/136,105

(22) Filed: Dec. 29, 2020

(51) Int. Cl. B23K 26/38; B23K 26/06; B23K 26/08; B23K 26/14

(52) U.S. Cl. CPC B23K 26/38; B23K 26/14; B23K 26/0853; B23K 26/0665

(57) ABSTRACT

A method of combined laser and oxy-cutting, including heating an area of the material to be cut to an enabling temperature range with a laser beam and introducing an oxygen stream into the heated area, thus cutting the material. Wherein the laser beam is directed in a periodic path.

### BACKGROUND

In the metalworking industry, thermal cutting processes such as laser cutting, plasma cutting and oxy-fuel cutting are often the most economical means available. Typically, they are suitable for preparing weld edges, for cutting component geometries, or for cutting pipes and profiles. All these thermal cutting processes utilize a concentrated high-energy heat source. And for all these processes the cutting speed decreases with increasing sheet thickness.

Laser cutting has gained in popularity but is limited when it comes to maximum thickness of metal cutting capability, typically of the order of 1 to 1.5 inch depending of laser power. This is in contrast with these other methods such as plasma cutting (up to 2 inch) and oxy-fuel cutting (12 inch thick steel slab is not uncommon). Abrasive water-jet are also common, and can cut up to 8 inch.

To increase the thickness capability, the laser industry has typically relied on simply increasing laser power. And still, even with a 12 kW laser power, can barely pass the 2 inch steel thickness cutting capability.

Alternatively, the industry has tried with the so-called LASOX process. This process consists of focusing the laser beam spot into a large spot on the workpiece, with enough energy density to heat it in conduction mode beyond 900 C. At these temperatures the oxy-cutting process is enabled by the exothermic oxidation of the metal which melts away due to an O2 flow, which creates the cut kerf.

While the laser is being used as a heat source, the cutting speed is being dictated mainly by the oxy-cutting process. Consequently, this method is more expensive in $/inch than the traditional oxy-fuel heating. This method is also challenged by difficulties in piercing and spatter projections on the optics. Another known method is where the laser beam is focused into a large ring mode spot on the workpiece. This ring spot is intended to be large enough to have the O2 flow blowing through the inner ring. This method leaves the focused spot operating in conduction mode to heat up the workpiece above 900 C so the oxy-cutting process can be enabled. In conduction mode, the cutting speed is again being dictated solely by the oxy-cutting process. A mechanical mean to get a focus spot to oscillate in periodic loop patterns has been utilized, however the requirement on keyhole mode across the closed pattern area has not been specified.

### SUMMARY

A method of combined laser and oxy-cutting, including heating an area of the material to be cut to an enabling temperature range with a laser beam and introducing an oxygen stream into the heated area, thus cutting the material. Wherein the laser beam is directed in a periodic path.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation a donut keyhole laser cutting, in accordance with one embodiment of the present invention.

FIG. 2A is a schematic representation of a non-circular periodic loop pattern, in accordance with one embodiment of the present invention.

FIG. 2B is a schematic representation of a non-circular periodic loop pattern in linear translation, in accordance with one embodiment of the present invention.

FIG. 3A is a schematic representation of an open donut periodic loop pattern, in accordance with one embodiment of the present invention.

FIG. 3B is a schematic representation of an open donut periodic loop pattern in linear translation, in accordance with one embodiment of the present invention.

FIG. 4A is a schematic representation of circular periodic loop pattern, in accordance with one embodiment of the present invention.

FIG. 4B is a schematic representation of circular periodic loop pattern in linear translation, in accordance with one embodiment of the present invention.

### ELEMENT NUMBERS

101=cutting nozzle
102=cutting gas flow
103=material to be cut
104=laser beam
105=focused laser beam spot
107=heat irradiation zone
200=period loop pattern
201=non-circular periodic loop pattern
202=open donut periodic loop pattern
203=circular periodic loop pattern

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present method utilizes the so-called LASOX principle, wherein the workpiece must be heated above a temperature of about 900-1000 C in order for the oxy-cutting process to be enabled. However, in the instant case, this is not achieved by focusing the laser beam into a very large spot or ring spot and heating the plate in conduction mode. Instead the present method utilizes a focused laser beam focused onto a tiny spot, thus creating a power density above the keyhole mode threshold of approximately 0.5 MW/cm2 at 1 micron wavelength. This focused spot also oscillates in a periodic pattern. This period pattern may be a circular or semi-circular closed loop patterns or similar open loop patterns. The focused spot oscillates at a high frequency of at least 0.5 kHz per each MW/cm2 of average power density in the area swept by the periodic loop pattern. This is to be done in such a way that the average power density of the area swept by the periodic loop pattern remains above keyhole threshold of about 0.5 MW/cm2.

The present method optimizes the maximum thickness capability of a laser cutting system by focusing the laser beam into a minuscule focused spot of diameter (d2−d1)/2. The focused spot may have a diameter of less than about 150 micron. The spot may be produced with a relatively long focal length focusing optic. The focusing optic may be more than 200 mm, preferably more than 300 mm. The focused spot may be oscillated at high speed across a periodic loop pattern irradiation area. This oscillation may be greater than 1 kHz; the faster the cutting speed, the greater the oscillation frequency should be. If the periodic loop pattern is for circular, then a circle of diameter d2 of between 1 to 3 or 4 mm (depending on thickness of the workpiece to be cut) is representative. Or if the focused spot is oscillated into a non-circular periodic loop pattern, it is even more efficient and achievable mechanically with galvano-mirrors or by other optical mean or electronic mean. This method remedies the primary deficiency of the existing so-called LASOX process. This method allows the cutting of a very thick plate with O2 assist gas. In fact, this method allows plates to be cut that are essentially as thick as with oxy-fuel cutting. The preferred orientation is to have the assist gas and the focused laser beam being delivered coaxially onto the workpiece through a common nozzle delivery. At the high frequency of motion oscillation of the tiny focused spot beam, the average power density received by the workpiece from the donut ring is also above the threshold for keyhole. This enables the laser to heat up the part of the workpiece in the inner part of the donut, while actually initiating the cut in keyhole mode in the ring of the donut itself. The beam oscillation in the donut keyhole ring area can be achieved mechanically by stirring optics at high frequency, optically or electronically by controlling the laser resonator.

The following equations define the present system.

Wherein:
d1=the inside diameter of the ring spot (see Figures) (Preferably d1>0.1 mm)
d2=the outside diameter of the ring spot (see Figures)
D=(d2−d1)/2
f=the focal length of the system (Preferably f>200 mm)
M²=the laser beam quality factor
λ=the wavelength of the laser
P=the power of the laser
P_{d}=the power density of the focused beam spot
Pₐ=average power density inside of ring
D˜M²*λ*f/(π*D)
P_{d}=P/(π*D²/4)>0.5 MW/cm2 (Preferably P_{d}>5 MW/cm2
Pₐ=P/[((π*d2²)/4)−((π*d1²)/4)] (Preferably Pₐ>0.5 MW/cm2)

Among the advantages of the present method over the existing art are the following. The long focal length for focusing the optic protects the optics from welding spatters. The long focal length yields a long Rayleigh length (Zr), thus providing better cutting quality during thick workpiece cutting. The keyhole mode in the donut area enables deep penetration cutting much faster while heating the workpiece much more efficiently. The hole in the donut area determines the kerf width; by enabling a large kerf of 1 to 2 mm, it enables a more effective flow of assist gas deep inside the kerf. Deep oxy-cutting with Oxygen assist gas and clean dross-free cutting with Nitrogen assist gas.

With the same laser machine and a simple focusing head retrofit for the present donut keyhole laser cutting, the end-user customer can cut much thicker plate, much faster than with oxy-fuel. Compared to traditional laser cutting, the cutting quality is superior because of much better assist gas flow in the wider kerf. The cutting speed is enhanced compared to traditional laser cutting.

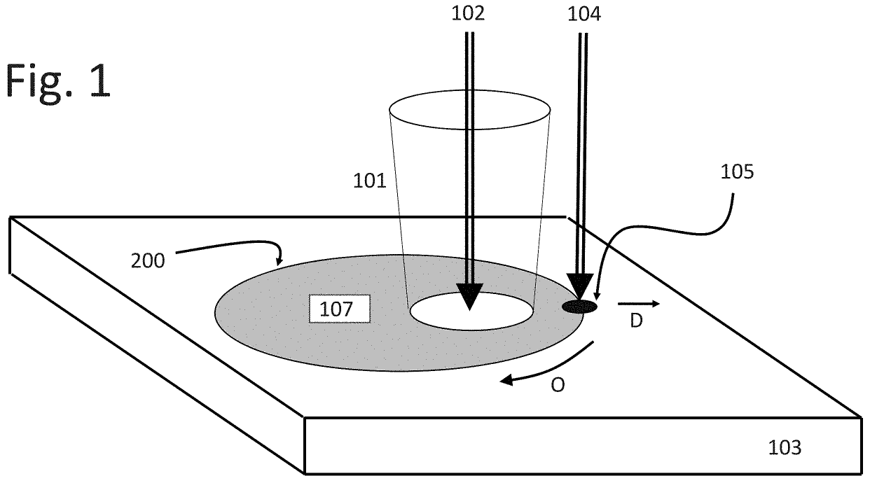

Turning to FIGS. 1-4b, a method of donut keyhole laser cutting is provided. A typical cutting nozzle 101 directs a cutting gas flow 102 to the surface of the material to be cut 103. Cutting gas 102 may be oxygen. A laser beam 104 is directed to form a focused spot 105. Focused spot 105 is directed in a period loop pattern 200, thus creating a heated irradiation zone 107. The heated irradiation zone 107 will reach temperatures near the ignition temperature, typically above 900 to 1000 C. When contacted with the cutting gas 102, the metal in the heated irradiation zone 107 will vaporize and create a hole in the material to be cut 103. As the laser beam 104 continues to oscillate around the period loop pattern 200, the cutting nozzle 101, and thus the cutting gas 102, move in a linear direction D across the material to be cut 103.

The heated irradiation zone 107 may have a power density above the keyhole mode threshold of 0.5 MW/cm2 at 1 micron wavelength. This allows the material to be cut 103 to boil and form a vapor column. A laser beam keyhole is thus formed, which penetrates the material to be cut, and is surrounded by molten material. As the cutting nozzle 101, and thus the cutting gas 102, move across the material to be cut 103, the keyhole, and the resulting penetration, move with it, thus, effectuating the cutting of the material to be cut 103.

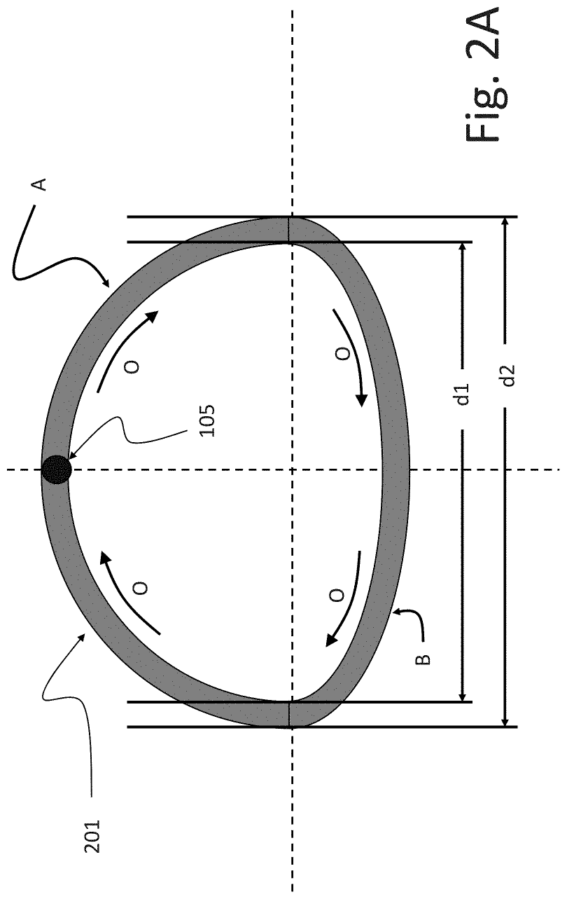

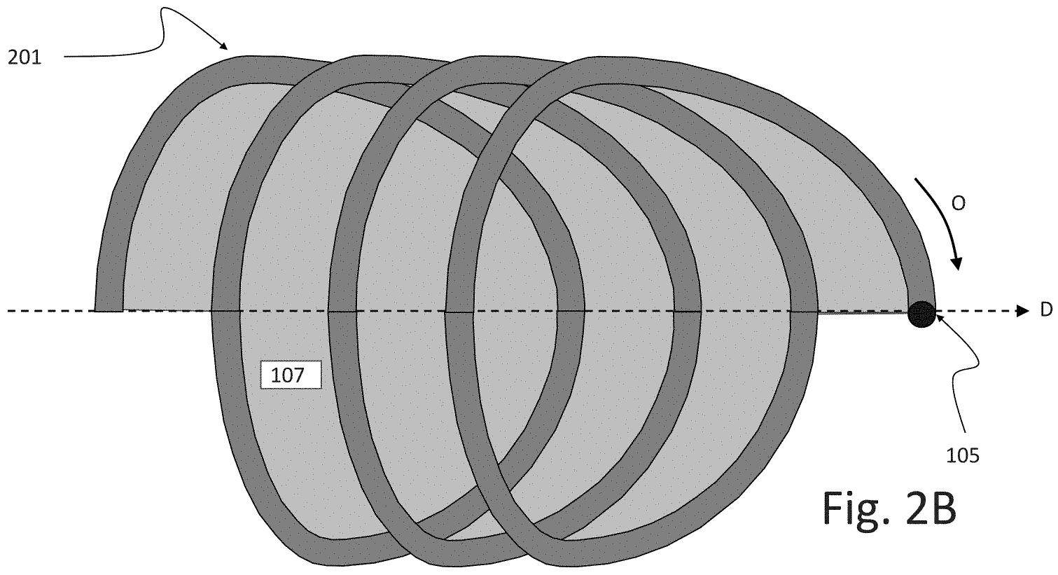

The periodic loop pattern may be of any practical shape available to the skilled artisan. As a non-limiting example, the periodic loop pattern may be non-circular 201 as indicated in FIGS. 2a and 2b. Although the oscillation direction O is indicated in the figures as being in the clockwise direction, the direction of the oscillation O may be either clockwise, counterclockwise, or may alternate between the two. This oscillation pattern can be asymmetrical, as in FIG. 2b, the portion A of the pattern which is more approximately circular is oriented in the leading direction. As for any given period, focused spot 105 will be in contact with the material to be cut longer in portion A than in portion B (the less approximately circular portion), this orientation provides maximum laser power to the heat effected zone 107. However, one skilled in the art may orient the non-circular periodic loop pattern 201 in the manner most suitable for the application.

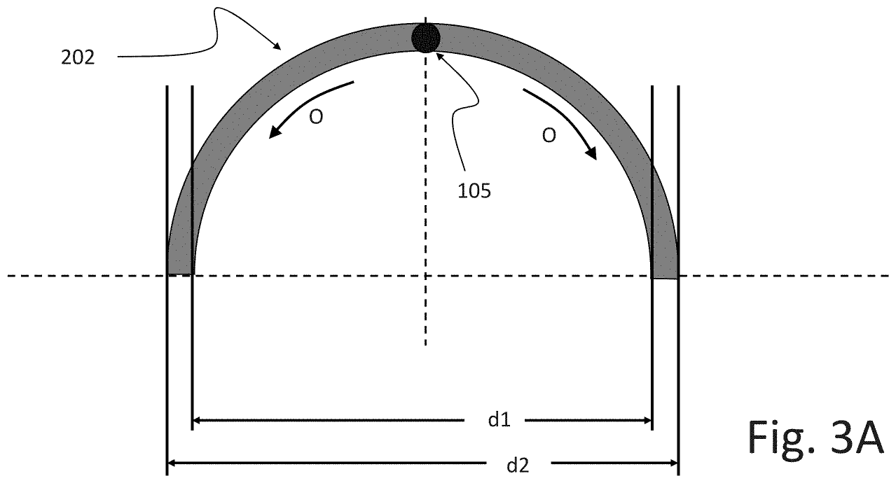

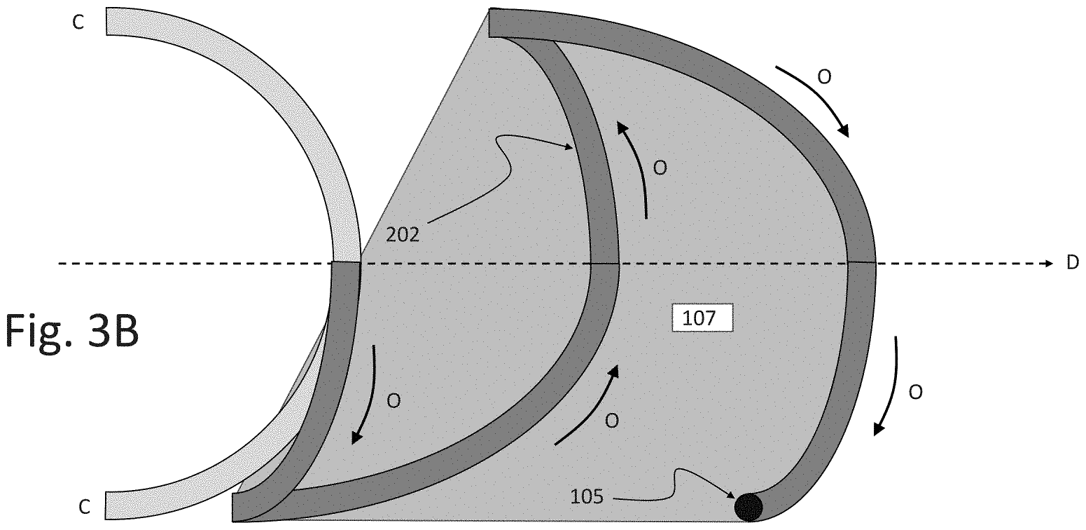

As another non-limiting example, may be a circular (semi-circular) or non-circular open donut 202 as indicated in FIG. 3. The direction of the oscillation O may be either clockwise, counter-clockwise, or may alternate between the two. This oscillation pattern introduces and concentrates laser power to the leading edge of heat effected zone 107 only. Thus, with all things being equal, may result in either increased cutting depth potential or increased cutting speed.

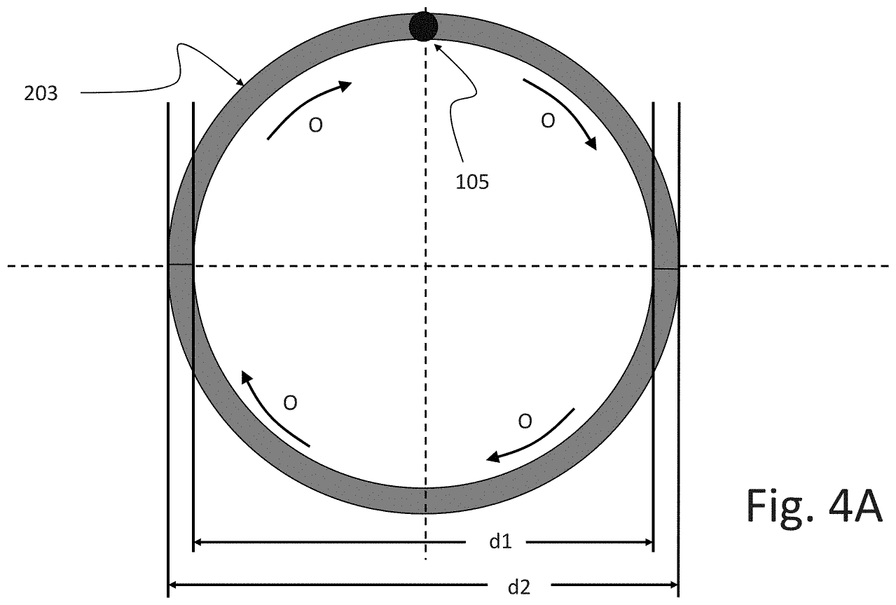

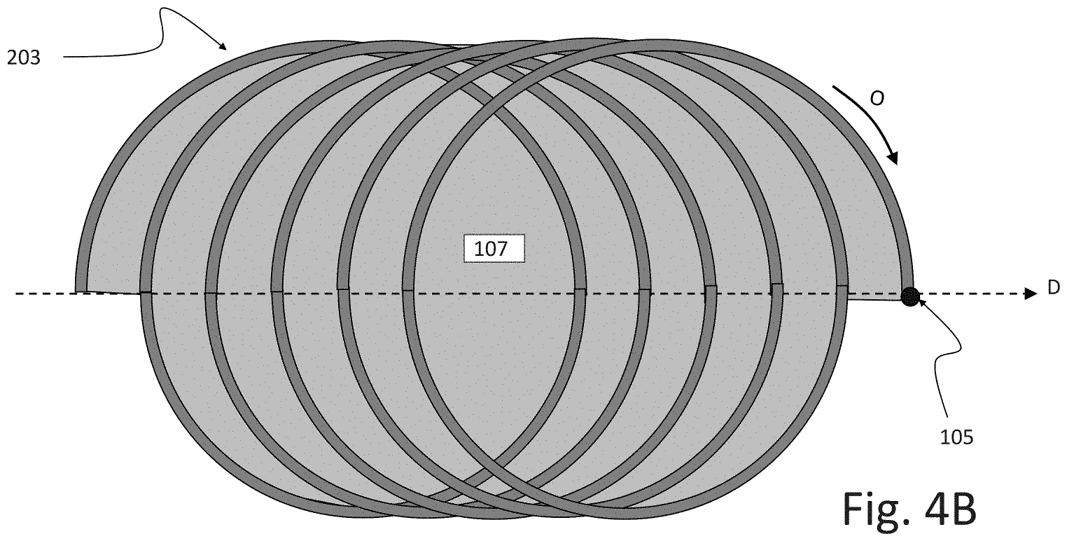

As yet another non-limiting example, may be a circular donut 203 as indicated in FIG. 4. The direction of the oscillation O may be either clockwise, counter-clockwise, or may alternate between the two. This oscillation pattern produces a more evenly distributed heated irradiation zone 107, and thus may be of more general application.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method of combined laser and oxy-cutting, comprising heating an area of the material to be cut to an enabling temperature range with a laser beam and introducing an oxygen stream into the heated area, thus cutting the material, wherein the laser beam is directed in a periodic path.

2. The method of claim 1, wherein the enabling temperature is above 900 C.

3. The method of claim 1, wherein the enabling temperature is above 1000 C.

4. The method of claim 1, wherein the laser beam produces an average power density in the area of the material to be cut of more than 0.5 MW/cm².

5. The method of claim 4, wherein the laser beam proceeds along the periodic curved path producing a swept area, wherein the laser beam oscillates at a frequency of greater than 0.5 kHz per each MW/cm² of average power density in the swept area.

6. The method of claim 1, wherein the laser beam is focused on the material to be cut with a focusing optic having a focal length of greater than 200 mm.

7. The method of claim 1, wherein the laser beam is focused on the material to be cut with a focusing optic having a focal length of greater than 300 mm.
